(19) United States
(12) Patent Application Publication
(10) Pub. No.: US 2005/0289519 A1
(43) Pub. Date: Dec. 29, 2005

(54) Fast approximation functions for image processing filters

(75) Inventors: Ali Sazegari, Cupertino, CA (US); Ralph Brunner, Cupertino, CA (US); John Harper, San Francisco, CA (US)

Correspondence Address: WONG, CABELLO, LUTSCH, RUTHERFORD & BRUCCULERI,;P.C., 20333 SH 249, SUITE 600, HOUSTON, TX, 77070, US

(73) Assignee: Apple Computer, Inc., Cupertino, CA (US)

(21) Appl. No.: 10/875,483

(22) Filed: Jun. 24, 2004

(51) Int. Cl. G06F 9/45

(52) U.S. Cl. 717/136; 708/300

(57) ABSTRACT

A specified collection of computationally expensive functions are identified and polynomial approximations thereto are determined. In the context of a graphical processing application in general, and image filters in particular, certain characteristics of the specified collection of computationally expensive functions (e.g., range, accuracy and allowable error) permit highly efficient (computationally low cost) approximations to be determined a priori. The substitute polynomial approximations may be compiled into filter programs that can execute on a computer system's central processing or graphical processing units.

### BACKGROUND

The invention relates generally to digital image processing and, more particularly, to substituting fast approximation functions for certain specified functions during digital filter compilation operations. The subject matter of the invention is generally related to the following jointly owned and co-pending patent applications: “System for Optimizing Graphics Operations” by John Harper, Ralph Brunner, Peter Graffagnino, and Mark Zimmer, Ser. No. 10/825,694; and “System for Emulating Graphics Operations” by John Harper, Ser. No. 10/826,744, each incorporated herein by reference in its entirety.

One significant aspect of graphics applications is their use of filters to modify or alter an image. In general, a filter is any function that may be performed on zero or more images. In slightly more particularity, a filter is a function that accepts images and other parameters (associated with and dependent upon the particular filter) as inputs and generates a new image as an output. Illustrative filter types include, but are not limited to, blur filters (e.g., Gaussian, box and ripple filters), enhancement filters (e.g., edge enhancement and sharpen filters), rotation filters, color manipulation filters and intensity modification filters.

Over the past several years the development of image processing technology has led to the wide-spread commercialization of computer systems that incorporate graphics processing units (“GPUs”). As a result of the power and flexibility offered by modem GPUs, it is common for graphics applications to rely on GPUs to execute their filters. While GPUs can provide a valuable computational resource, there are times when it would be inappropriate to use a GPU to execute a filter. For example, a GPU may not be available, the GPU's video memory may be insufficient, the number and/or size of textures needed by the filter may exceed the GPU's capacity, the program needed to implement the filter may exceed the GPU's capability, or the accuracy required by the filter is greater than the GPU's capability to provide. (A discussion of the circumstances, and methods to detect and respond to these circumstances may be found in the above-identified co-pending patent applications.) In situations such as these, a computer system's CPU must be used.

Often times, filters incorporate functions that are computationally costly to evaluate. That is, there are functions that require large amounts of CPU time to execute and/or require large amounts of system memory. These types of functions are referred to as computationally costly. Transcendental functions are one example of costly functions. Another function is the power function.

When a filter is executed using a computer system's CPU, these functions can have a significant and deleterious impact on the performance of the image processing application. Thus, it would be beneficial to provide a means to automatically detect and substitute less computationally costly functions when a filter program is executed by a computer system's CPU. It would also be beneficial to provide a means to automatically detect and substitute less computationally costly functions when a filter program is executed by a computer system's GPU.

### SUMMARY

In one embodiment of the invention, a specified collection of computationally expensive functions used during image processing filter operations are identified and polynomial approximations thereto are determined. During filter program compilation, instructions implementing a substitute polynomial approximation function are substituted for each specified computationally expensive function. In one embodiment, the specified collection of computationally expensive functions comprise transcendental functions. In another embodiment, the compile-time substitution is made only if the filter program is to execute on a computer system's central processing unit (as opposed to dedicated graphics processing hardware). In still another embodiment, the compile-time substitution is made regardless of whether the filter program is executed by the computer system's central processing unit or an associated graphics processing unit. Methods in accordance with the invention may be stored in any media that is readable and executable by a computer system.

### BRIEF DESCRIPTION OF THE DRAWINGS

FIG. 1 shows, in block diagram format, phase 1 operations in accordance with one embodiment of the invention.

FIG. 2 shows, in flowchart format, phase 2 operations in accordance with one embodiment of the invention.

FIG. 3 shows, in flowchart format, phase 2 operations in accordance with another embodiment of the invention.

### DETAILED DESCRIPTION

Techniques (including methods and devices) to automatically detect specified computational expensive functions and substitute computationally less expensive approximations thereto are described. In general terms, the invention optimizes certain predetermined functions associated with an image processing filter for execution on a computer system's central processing unit (“CPU”) as distinguished from the computer system's graphics processing unit (“GPU”). It will be recognized that a computer system may comprise more than one CPU and/or more than one GPU. For simplicity of discussion however, and without so limiting the invention, the invention is described in terms of a single CPU and single GPU system. The following embodiments of the invention, described in terms of substitute transcendental functions are illustrative only and are not to be considered limiting in any respect.

In accordance with the invention, generation and use of fast approximation functions for use in image processing filters may be described in two phases. In a first phase, computationally costly functions (“target functions”) are identified and appropriate polynomial approximations are determined. In a second phase, polynomial approximations are substituted, at filter program compilation time, for the previously identified target functions. By properly selecting the polynomial coefficients, the resulting function can execute extremely fast while providing an accuracy that is suitable to the processing task, e.g., image processing.

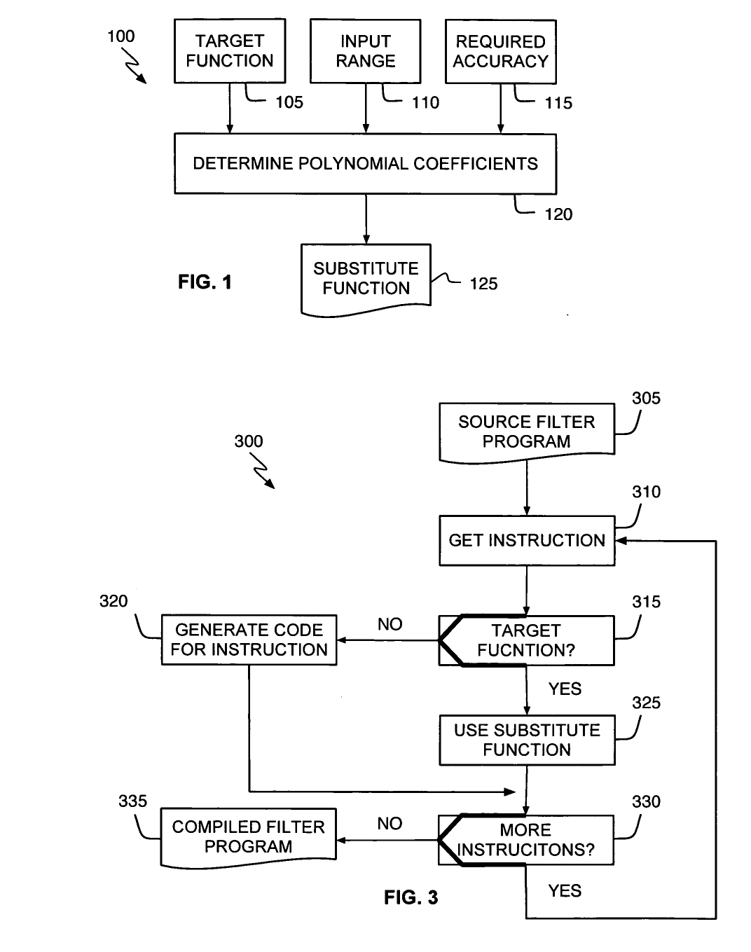

Referring to FIG. 1, phase 1 100 includes identifying a target function (block 105) and specifying the function's input range (block 110) and required accuracy or, equivalently, the maximum allowable error (block 115). While literally any accuracy may be specified, in practice accuracy may be determined by what typical filters use the target function for. For example, if the target function is used to calculate a color, an accuracy of approximately 10 bits is all that is needed as this corresponds to the number of shades that a typical human eye can discern. On the other hand, if the target function is used to calculate a coordinate for an image (typically in the thousands of pixels), an accuracy of 12 bits may be needed. While the inventive technique is not so limited, in the embodiments described herein, target functions comprise the transcendental functions sin(x) and cos(x). Other target functions may include additional transcendental functions (e.g., the arcsin function) as well as, for example, the power function. These functions are known to be computational costly when executed using standard, or vectored, system library calls. With this information, coefficients for a polynomial approximation function are determined (block 120), the result being substitute function 125. It will be recognized that the degree of substitute function 125 is determined by the required accuracy. That is, the degree of substitute function 125 is generally selected as the lowest degree polynomial that satisfies the required accuracy constraint (see block 115).

With respect to transcendental functions, graphics applications are unique in the sense that the range over which they operate are bounded—the sine and cosine of an angle, in the context of a graphics application, are known to be between ±π. Thus, all parameter values to these functions (and similar functions such as the SCS function that returns two values: the sine and cosine of the input parameter) may be forced to lie between these values without any loss of accuracy or use.

With these parameters known and fixed (i.e., range 110 and accuracy 115), extremely fast and mathematically well-behaved polynomial approximations may be determined. In one embodiment, the class of approximation functions known as Chebychev mini-max polynomials are used. Coefficients for Chebychev mini-max polynomials may be determined in accordance with a variety of techniques such as, for example, Differential Correction, Remez Equiripple Exchange, Semi-Infinite Linear Optimization and various parametric heuristics.

In an embodiment targeted for digital image processing, Chebychev mini-max polynomials for the sine and cosine function were generated for the parameters identified in Table 1. One of ordinary skill in the art will recognize that the precise polynomial (e.g., the “degree” and coefficient values) depend upon the precise amount of error that one's application can tolerate. It is known that as the amount of permissible error between a value generated by the approximation polynomial and that generated by the “true” function decreases, the larger the degree of the polynomial. While yielding improved accuracy (i.e., reduced error), a drawback is that the polynomial approximation takes more multiply and add operations to generate a result. Accordingly, it is a matter of design choice as to what precise degree a polynomial approximation in accordance with the invention assumes.

TABLE 1
Illustrative Polynomial Input
Parameters

| Function | Range | Accuracy |
|---|---|---|
| sine | −π → +π | 7 bits |
| cosine | −π → +π | 9-bits |

While use of Chebychev mini-max approximation polynomials are computationally intensive to determine, as long as the input parameters identified above (i.e., range and accuracy) remain fixed, the coefficients do not change. Accordingly, once determined, the above polynomial approximations may be used on an on-going basis in a graphics application.

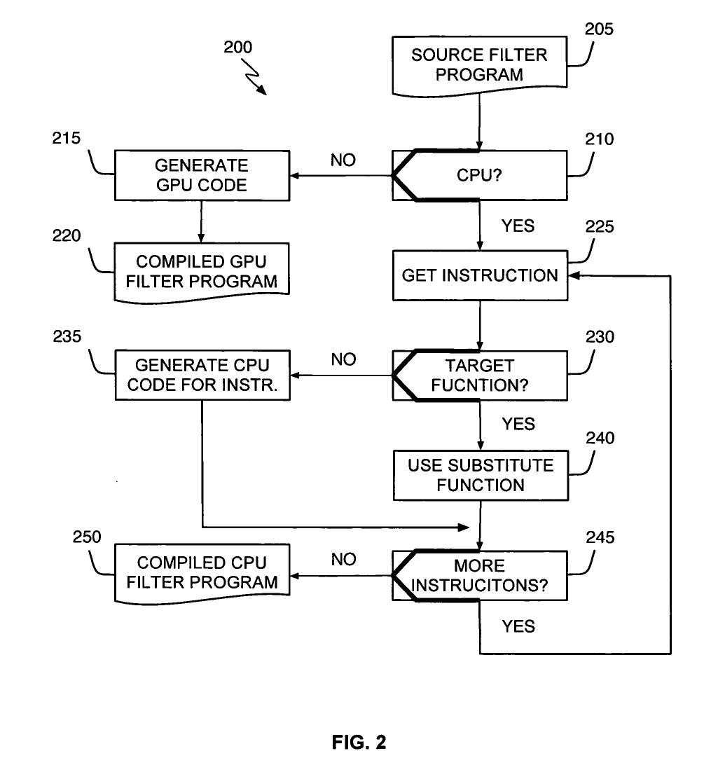

With polynomial approximations determined in accordance with FIG. 1, one embodiment of phase 2 operations is shown in FIG. 2. At compilation time, source filter program 205 is checked to determine if the computer system's CPU or GPU should be used to execute the compiled filter program. It will be recognized that the instructions comprising filter program 205 may include conventional programming functions such as those available through standard C and C++ programming libraries as well as specialized functions available through dedicated graphics libraries and/or application program interfaces (“APIs”).

If the GPU is selected (the “No” prong of block 210), GPU code is generated (block 215) resulting in compiled GPU program 220. If the CPU is selected (the “Yes” prong of block 210), a first instruction from source filter program 205 is obtained (block 225). If the instruction does not correspond to a target instruction (the “No” prong of block 230), the instruction is compiled in accordance with standard practice (block 235), after which compilation continues at block 245. If the instruction corresponds to a target function (the “Yes” prong of block 230), compiled instructions corresponding to the function's polynomial approximation are used (block 240). If additional instructions remain to be compiled (the “Yes” prong of block 245), compilation continues at block 225. If no additional filter programs remain to be compiled (the “No” prong of block 245), generation of compiled CPU filter program 250 is complete.

As noted above, use of polynomial approximations in accordance with the invention can provide significant speed improvements when executing an image processing filter using a computer system's CPU. For example, execution of a sin(x) function using a standard C system library call (e.g., sin( )) takes approximately 341 clock cycles per-element. Executing the same function using a vector library call (e.g., vsinf( )) takes approximately 93 clock cycles per-element. Using a polynomial approximation in accordance with the invention, however, takes only 2-5 clock cycles per-element. (These results were obtained on a Macintosh G4 computer system executing the OS X operating system, as supplied by Apple Computer, Inc. of Cupertino, Calif.)

Referring to FIG. 3, in another embodiment instructions embodying substitute polynomial functions in accordance with the invention may also be used for a program designed to execute on a GPU. In this embodiment, compilation process 300 takes source filter program 305 instruction by instruction (block 310), generating standard GPU code for non-target function instructions (blocks 315-320) and polynomial approximation code for target instructions (blocks 315, 325). This process is repeated until all source program instructions are compiled (block 330). The result is compiled filter program 335 that may be executed on a GPU.

It has been determined that on some GPUs, polynomial approximations in accordance with the invention may execute faster than native GPU functions. Another benefit of this approach is that the result of a filter operation would be the same regardless of whether it was performed by the CPU or the GPU (when both used polynomial approximations in accordance with the invention). Yet another benefit of substituting polynomial approximations into GPU programs is that GPUs typically have only single-element sine and cosine capabilities. That is, most GPUs will execute a sine or cosine function on only one pixel/element at a time. In contrast, polynomial approximations in accordance with the invention may be applied to vectors so that a sine, or cosine, function may be evaluated on a plurality of elements at once.

Various changes in the details of the illustrated operational methods are possible without departing from the scope of the following claims. For instance, filter compilation in accordance with FIG. 2 may be performed using conventional compilers that generate machine executable code a priori, or just in time compilers that generate machine executable code immediately prior to the resulting code's execution. In addition, acts in accordance with FIG. 2 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

The preceding descriptions are presented to enable any person skilled in the art to make and use the invention as claimed and is provided in the context of the particular examples discussed below, variations of which will be readily apparent to those skilled in the art. Accordingly, the claims appended hereto are not intended to be limited by the disclosed embodiments, but are to be accorded their widest scope consistent with the principles and features disclosed herein.

1. A method to approximate functions in an image processing application, comprising:
identifying a target function in an image filter program; and
substituting a polynomial approximation for the target function in a compiled version of the image filter program.

2. The method of claim 1, wherein the polynomial approximation comprises a Chebychev mini-max approximation polynomial.

3. The method of claim 1, wherein the target function comprises a transcendental function.

4. The method of claim 3, wherein the transcendental functions are range limited to ±π.

5. The method of claim 3, wherein the transcendental functions comprise combinations of one or more of a sine function and a cosine function.

6. The method of claim 1, wherein the act of identifying comprises identifying a sine function or a cosine function.

7. The method of claim 1, wherein the act of substituting is performed by a just-in-time compiler application.

8. The method of claim 1, wherein the compiled version of the image filter program executes on a computer system central processing unit.

9. The method of claim 1, wherein the compiled version of the image filter program executes on a graphics processing unit.

10. The method of claim 1, wherein the acts of identifying and substituting are performed only if the compiled version of the image filter program is not going to execute on specialized graphics hardware.

11. A compiler application for compiling image filter programs, said compiler application comprising instructions stored on a program storage device for causing a programmable control device to:
identify a target function instruction in an image filter program; and
substitute polynomial approximation instructions for the target function instructions in a compiled version of the image filter program.

12. The compiler application of claim 11, wherein the instructions to identify a target function comprise instructions to identify a transcendental function.

13. The compiler application of claim 12, wherein the instructions to identify a transcendental function comprise instructions to identify combinations of one or more of a sine function and a cosine function.

14. The compiler application of claim 11, wherein the instructions to substitute polynomial approximation instructions for a target function comprise instructions to substitute instructions embodying a Chebychev mini-max approximation polynomial.

15. The compiler application of claim 11, wherein the instructions to identify and substitute are executed by a just-in-time compiler application.

16. The compiler application of claim 11, wherein the compiled version of the image filter program execute on a computer system central processing unit.

17. The compiler application of claim 11, wherein the compiled version of the image filter program execute on a graphics processing unit.
